(19) United States
(12) Patent Application Publication
(10) Pub. No.: US 2020/0316555 A1
(43) Pub. Date: Oct. 8, 2020

(54) REACTOR SYSTEM FOR CONTINUOUS FLOW REACTIONS

(71) Applicant: hte GmbH the high throughput experimentation company, Heidelberg (DE)

(72) Inventors: Stephan A. SCHUNK, Heidelberg (DE); Jaroslaw Michael MORMUL, Ludwigshafen am Rhein (DE); Frank GUELLICH, Heidelberg (DE); Oliver KOECHEL, Heidelberg (DE); Michael DEJMEK, Heidelberg (DE)

(21) Appl. No.: 16/956,773

(22) PCT Filed: Dec. 20, 2018
(86) PCT No.: PCT/EP2018/086152

§ 371 Date: Jun. 22, 2020

(30) Foreign Application Priority Data
Dec. 21, 2017 (EP) 17209710.7

(51) Int. Cl. B01J 19/00; C07B 33/00

(52) U.S. Cl. CPC B01J 19/0093; C07B 33/00; B01J 2219/00033; B01J 2219/0086; B01J 2219/00808; B01J 2219/00822; B01J 2219/00835; B01J 2219/0079

(57) ABSTRACT

The invention relates to a reactor system for continuous flow reactions that comprises at least two blocks (1, 2), two interlayers (8, 9) and a contact pressure device, and at least one inlet (10) and one outlet (11), wherein the first block (1), the interlayers (8, 9) and the second block (2) form a stacked arrangement fixed by the contact pressure device and, in the reactor system, at least one interlayer comprises a sealing layer (8) and one interlayer comprises channel structure element (9) comprising a reaction channel, wherein the inlet (10) is functionally connected to the inlet side of the reaction channel and the outlet (11) to the outlet side of the reaction channel, and the stacked arrangement is detachable.

The invention relates to a reactor system for continuous flow reactions that comprises at least two blocks (1, 2), two interlayers (8, 9) and a contact pressure device, and at least one inlet (10) and one outlet (11), wherein the first block (1), the interlayers (8, 9) and the second block (2) form a stacked arrangement fixed by the contact pressure device and, in the reactor system, at least one interlayer comprises a sealing layer (8) and one interlayer comprises channel structure element (9) comprising a reaction channel, wherein the inlet (10) is functionally connected to the inlet side of the reaction channel and the outlet (11) to the outlet side of the reaction channel, and the stacked arrangement is detachable.

The development and optimization of reactor systems for continuous flow reactions are of great industrial interest. By means of the reactor system, data intended to enable a specific prediction as to how industrial scale processes can be readjusted are generated. The improvement in accuracy of reaction systems is helpful for development of new industrial scale processes or for further improvement of existing industrial scale processes. Process development is directed to the saving of energy and resources, in order thus to contribute to a decrease in carbon dioxide emission.

The reactor systems that are used in the laboratory are of central significance in research and development. Specialist literature and patent specifications give numerous descriptions of different reactors or microreactors that are used in the laboratory for research purposes. It is a characteristic feature of the reactors used in the laboratory for research purposes that these have small dimensions, the volume of the reaction spaces often being less than 10 mL, and are operated with small amounts of chemicals. The part that follows gives a brief summary with regard to the different reactors or microreactors that have been disclosed in the prior art.

In EP application EP 2 113 558 A2, Y. Asano et al. describe a microreactor constructed from plates in which there are channels. Asano et al. disclose and claim a reactor in which the surface-to-volume ratio varies within a reaction channel. In the reactor disclosed by Asano, it is preferable when the surface-to-volume ratio upstream is greater than that downstream.

In U.S. Pat. No. 7,534,402 B2, J. D. Morse et al. describe a microreactor for production of hydrogen as fuel. One aspect of the invention also relates to a membrane surface integrated into the microreactor, with the aid of which the hydrogen produced in the microreactor is separated off.

In U.S. Pat. No. 7,678,361 B2, G. Markows et al. describe a microreactor in which the channels are present in plates. Stacked arrangements of reaction channels and heat carrier fluid are described.

One aspect of the microreactor is that the channels can be coated. By virtue of the direct contact of the reaction channels with adjacent channels containing the heat carrier fluid, it is possible to very accurately control the reaction temperature within the reaction channels.

In US patent application US 2007/0161834 A1, Kobayashi et al. describe a microreactor in which the channels are present on a substrate. The catalyst is in supported form on a surface of the channel walls. The catalyst here is incorporated into a polymer. The invention relates to a method in which gas and liquid are guided through the reaction channel and there is a reaction which is catalyzed by the solid-state catalyst integrated into the polymer.

In PCT application WO 2004/022233 A1, Summersgill describe a modular microfluidic system. The modular microfluidic system has different assemblies including a base plate. It is possible to attach different microfluidic modules to the base plate in a detachable manner, and individual components may have a chiplike construction.

A further microreactor system is described in PCT application WO 2007/112945 A1 by Roberge et al. The microreactor system is a stacked arrangement of process modules having intermediate modules as heat exchanger modules. By means of the heat exchanger modules, the adjacent plates are heated or cooled. The heat exchanger modules in the different slices have a common thermal fluid feed and thermal fluid drain. Within the stack, the thermal fluid is also transported through the plates by the reaction channels.

PCT application WO 2012/025224 A1 by C. Stemmert describes a microfluidic apparatus constructed from plates in a stacked arrangement. The plate with the microfluidic channels is encompassed by plates that function as heat exchangers.

In EP patent EP 1 031 375 B1, S. Oberbeck et al. claim and disclose a microreactor for performance of chemical reactions, wherein the microreactor has horizontal reaction spaces stacked one on top of another. The sealing zones of the plates or layers are pressed against one another here in a sealing manner by virtue of sufficient contact pressure. It is stated that the stack has different function modules and the stack of function modules is encompassed by a housing having connections for the feed and drain.

Furthermore, PCT application WO 2015/087354 A2 by A. A. Kulkarni describes a microreactor constructed from metal, wherein the reaction channels are lined with glass. The metal reactor is framed by metal rings.

One of the objects underlying the invention is that of providing a reactor having good ease of handling. One of the capabilities of the reactor is to be that it can also be operated in the presence of solid-state catalysts. The reactor is to be usable under operating conditions at high pressure. Furthermore, it was also desirable for the catalyst change to be achievable rapidly and with a low level of complexity.

The aforementioned objects and also further objects can be achieved in that a reactor system for continuous flow reactions is provided, comprising at least two blocks (1, 2), two interlayers (8, 9) and a contact pressure device, and at least one inlet (10) and one outlet (11), wherein the first block (1), the interlayers (8, 9) and the second block (2) form a stacked arrangement fixed by the contact pressure device and, in the reactor system, at least one interlayer comprises a sealing layer (8) and one interlayer comprises channel structure element (9) comprising a reaction channel, wherein the inlet (10) is functionally connected to the inlet side of the reaction channel and the outlet (11) to the outlet side of the reaction channel, and the stacked arrangement is detachable.

The detachable connection of the apparatus elements is advantageous since the reactor system can be assembled and disassembled in a simple manner and can also be used repeatedly.

This makes it possible to subject the catalysts and/or catalyst foils analyzed by means of the reactor system, after the performance of a catalytic test reaction, to a visual and/or analytical characterization without any change in the form thereof. One embodiment of the reactor system of the invention in conjunction with the catalyst foils is particularly advantageous since this also offers the option of conducting fundamental experiments aimed at analytically detecting changes in the catalyst material.

In a preferred embodiment, in the reactor system, one of the blocks, on the contact side with the opposing block, has an elevation or base with a flat end face and one of the blocks, on the contact side with the opposing block, has a depression with a flat base and, in the presence of the stacked arrangement, the elevation or base is positioned in the depression and the interlayers (8, 9) are disposed in the region between the end face of the base and the base of the depression. It is thus preferable that one block takes the form of a male part (die) having an elevation and the other block the form of a female part having a depression to receive the elevation, it being preferable that the elevation or the depression has a flat boundary surface. Preferably, the channel structure element (9) is positioned in the depression. The advantage from the complementary arrangement of the shapes of the blocks (1) and (2) on the contact surface side results arises from the fact that the die can be fixed efficiently well in the depression when the blocks are pressed together, since this constitutes a guide

There are also conceivable embodiments in which the flat surfaces are replaced by differently shaped sealing bodies having, for example, a curved (or raised) sealing surface, or an angular or semicircular contour. Such embodiments enable significant local compression that requires a dis-tinctly lower compression force for a sealing effect compared to plane-parallel sealing surfaces.

In addition, it is also preferable that the base with the flat end surface is configured as a cylindrical plate and the depression with the flat base is configured as a cylindrical hole.

The reactor system of the invention offers the advantage that the components of the reactor system can be exchanged in a simple manner. For example, different channel structure elements (9) can be used in a variable manner. The different channel structure elements (9) may differ, for example, with regard to size, the design of the reaction channels, or in relation to the material from which they have been manufactured.

In a further embodiment, in the reactor system, at least one interlayer that comprises channel structure element (9) forms an integral constituent of the contact surface of one of the blocks, or the respective interlayer that takes the form of a channel structure element (9) form integral constituents of the contact sides of the respective blocks. (It is preferable that the contact pressure device comprises screws arranged laterally in the edge region of the blocks. The contact pressure device preferably comprises at least four screws.)

In relation to dimensioning of the reactor system, it should be noted that preference is given to an embodiment in which the interlayers have a diameter in the range of 0.5-200 cm, the diameter of the interlayers further preferably being in the range of 1-50 cm, further preferably in the range of 1.5-15 cm.

The flexibility of the reactor system of the invention is advantageous since this results in various possible uses, such that the reactor system can be used in the field of research and development or else in the field of production. In the embodiment for utilization in the field of production, the reactor system has dimensions greater than the dimensions for the use of the reactor system in the field of research and development. The use of the reactor system of the invention in the field of production offers the advantages that result from microreactor technology over conventional reactors. These advantages include better mixing of the reactants and better ability to react them under very well controlled conditions. This is especially true in relation to the control of temperature and dwell time, with the accuracy of temperature control preferably characterized by temperature variations of not more than +/−2.5° C., the variation in temperature further preferably being not more than +/−1.5° C., and the variation in temperature even further preferably being less than +/−0.5° C. Preferably, the dwell time is controlled with an accuracy where the variations are not more than +/−15 s, the variations further preferably being not more than +/−10 s, the control of dwell time especially preferably being such that the variations are not more than +/−5 s. The dwell time corresponds to the quotient of the volume of the reaction space to the exit volume flow rate. In the field of research and development, a particular advantage arises from the fact that the elements of the reactor system and the catalyst can be subjected to analytical characterization after the performance of the method. Channel structure elements may be manufactured from different materials and tested in order to assess chemical resistance with regard to the studies conducted in the reactor. As a result, it is possible to obtain findings as to how an industrial scale reactor should be designed for it to be operable in a corrosion-resistant manner.

Preferably, the reactor system of the invention is operated in an embodiment in which the channel structure element (9) is in contact with a catalyst film. Another advantageous aspect of this configuration is that the catalyst film, after the conclusion of the chemical analysis, can be dein-stalled in a nondestructive manner from the reactor system and subjected to an analytical characterization. By means of this analytical characterization of the aged catalyst film, it is possible to find out information as to the relationship between the structure of the catalyst material and the reaction activity observed in the experiments. Another conceivable embodiment of the reactor system is one in which a region of the reaction channel is functionally connected to a measurement probe that enables implementation of online spectroscopy studies on the product streams or the catalyst film during the performance of the chemical process. Such an embodiment would result from arrangement of the measurement probe in one of the blocks (1, 2) that surround the channel structure element (9) and the sealing element (8).

The term “contact pressure device” in the context of the present description means that elements that exert a high contact pressure force on the blocks (1, 2) are used. The contact pressure device (3) may comprise elements that may be selected from the group of press, screw clamps, clamps, spring press, screws. The contact pressure devices preferably comprises screws as elements. The securing elements are preferably disposed in the edge region of the blocks (1, 2). For example, in one embodiment which is shown in FIG. 5, an edge region is shown there in the form of a circular plate having an arrangement of six passages. The tips of the screws are guided through the passages into the blocks (1, 2) and the blocks are pressed against one another by the contact surfaces. In the case of polymeric sealing materials, it is preferable that the compression force that acts on the contact surface of the blocks (1, 2) is greater than 1 kN per cm², the compression force acting on the contact surface further preferably being greater than 2 kN per cm². The compression force depends on the sealing element material chosen in the particular case. In the case of metallic sealing materials, the compression force is also in the region of 10 kN per cm² or greater.

The term “block” in the context of the present description means that it is a solid component having a flat contact surface that shows only an insignificant change in shape, if any, under high contact pressure. It is preferable a block comprises a metallic material, where the block preferably has a height of ≥0.5 cm. The height of the block is further preferably ≥0.75 cm, and the height of the block is even further preferably ≥1 cm. In one preferred embodiment, cooling and/or heating elements for removal or for supply of heat are also arranged within the block. The statement of the height of the block relates to the extent of a block in a direction at right angles to the contact surfaces.

In a preferred embodiment, in the channel structure element, the reaction channel that runs through the channel structure element (9) has a meandering configuration. It is preferable that the diameter of the reaction channel is in the range of 50-2500 μm, and the depth of the reaction channel in the range of 10-1500 μm.

Preferably, the diameter of the reaction channel is in the range of 100-2000 μm, and the depth of the channel in the range of 50-500 μm. The land width that results from the separation between two adjacent channel lines is preferably in the region of greater than 2 mm.

What is meant by the term “meandering” in relation to the reaction channel is that the reaction channel can have windings in the form of loops, rectangular windings, sinusoidal windings, trian-gular windings. It follows that the longitudinal axis of the reaction channel is arranged in the plane of the channel structure element (9) or runs parallel to the channel structure element (9). Techniques that can be used to manufacture the channel structure element include the following techniques: milling, laser milling, drilling, etching, three-dimensional printing and sintering.

In a further-preferred embodiment, the surface of the channel structure element has been coated with a ceramic or glass coating, it being preferable that the regions of the land surface are configured without ceramic or glass coating. The land surfaces are subjected to the effect of the contact pressure and are subjected to high mechanical stress.

In a preferred embodiment, the channel structure elements (9) also have mixing elements that are preferably disposed in the entry region of the reaction channel. The mixing elements result in mixing of the reactant fluids supplied. Also conceivable are embodiments of the reactor system in which the entry region of a reaction channel has been equipped with two or more feed conduits. For example, in the case of two feeds, these may be configured in the form of one or more Y-pieces or in the form of one or more T-pieces.

Preferably, the at least one sealing layer (8) has a thickness in the range of 0.1-10 mm. Preferably, the at least one sealing layer (8) has a thickness in the range of 0.15-5 mm.

Preference is given to an arrangement of the reactor system that comprises a catalyst foil (15) disposed between a sealing layer (8) and a channel structure element (9). Preferably, the thickness of the catalyst foil (15) is within a range of 0.08-1 mm.

In a preferred embodiment, in the reactor system, at least one of the interlayers comprises a compressible, viscoelastic or plastic material that acts as sealing element. Preferably, the compressible, viscoelastic or plastic material comprises a material from the group of the polymer materials, for example Teflon or POM, or from the group of the inorganic materials, for example a carbonaceous material or a metallic material. The carbonaceous material is preferably graphitic carbon and further preferably expanded graphitic carbon. The metals are metals from the group of copper, aluminum, gold, lead, preference being given to soft metals, especially metals from the group of copper, lead, aluminum and alloys of these metals.

The expanded graphitic carbon is carbon obtainable in thin layers. For example, expanded graphitic carbon is available under the trade name Sigraflex from SGL Carbon. The abbreviation POM means polyoxymethylene. The term Teflon also includes Teflon-containing materials such as PTFE (i.e. polytetrafluoroethylene), FKM (i.e. fluorine-carbon rubber, available under the Viton trade name). FFKM perfluoro elastomer=Kalrez.

Preference is also given to the use of seal materials or interlayer materials that have plastic de-formability. It is a characteristic feature of plastically deformable materials that they are deformed irreversibly (“flow”) under application of force once a yield point has been exceeded, and retain this form after the application of force. Below the yield point, only elastic deformations occur, if any.

In a preferred embodiment, the blocks (1, 2) comprise a metallic material selected from the group of copper, brass, aluminum, iron, iron-containing steel, stainless steel, nickel-chromium stainless steel, high-alloy corrosion-resistant stainless steels. (Preferably, the blocks comprise stainless steel as metallic material. It is further preferable that the blocks are equipped with heating and/or cooling elements. Furthermore, it is preferable that the blocks comprise sensor elements with which, for example, the temperature of the block can be measured. It is even further preferable that the sensor elements comprise microfiber cables with which in situ spectroscopy studies are conducted on the fluid or on the catalyst foil (15).) It is also further preferable that the channel structure element or parts of the block have been coated with a ceramic protective layer.

In a further embodiment, the reaction channel of the channel structure element (9) has been filled or coated with catalyst. (Preferably, the reaction channel has been filled with pulverulent catalyst having an average particle size in the range of 10-100 μm smaller than the depth of a reaction channel.)

The reactor system for continuous flow reactions is integrated into an apparatus for performance of catalytic conversions and test reactions, wherein the apparatus comprises a reactant feed for supply of liquids and/or gases, including carrier fluid in the form of liquids and gases, the reactant feed comprises elements from the group of mass flow controller, high-pressure pump, gas saturator, the apparatus further preferably comprising means of analysis of the product streams, and the apparatus even further preferably having been equipped with a control and/or monitoring device.

The reactor system of the invention can be used for performance of homogeneously catalyzed or heterogeneously catalyzed reactions. The reactions may be organic syntheses of low molecular weight organic molecules or else the preparation of oligomers or polymers. In a preferred embodiment, the reactor system of the invention is operated in the presence of a catalyst. More preferably in the presence of a catalytic film. The reactor system may be supplied with liquid and/or gaseous fluids.

The invention also relates to a method of performing catalytic reactions by means of the reaction system detailed in the context of the disclosure. In the method, it is preferable that the reactor system is stored at a temperature in the range of 20-200° C., preferably at a temperature in the range of 50-190° C., further preferably at a temperature in the range of 80-180° C.

In a preferred embodiment, the method of the invention is performed at a pressure in the range of 0.05-300 barg, further preferably at a pressure in the range of 0.1-100 barg, even further preferably at a pressure in the range of 0.5-60 barg. Especially preferred is the performance of the method of the invention in the form of a high-pressure method at a pressure in the range of 10-300 bar, further preferred is the performance of a high-pressure method at a pressure in the range of 20-250 bar, and even further preferred is the performance of a high-pressure method at a pressure in the range of 45-200 bar.

Furthermore, in a preferred embodiment of the method, the method is performed at a flow rate in the range of 0.05-100 mL/min, preferably at a flow rate in the range of 0.1-50 mL/min, even further preferably at a flow rate in the range of 0.2 to 2.5 mL/min.

Another advantage that should be mentioned is that the reactor system can be operated in conjunction with the processing of different fluid mixtures in the Taylor flow regime in a very simple manner. This makes it possible to mix the reactant fluids used for the reaction in a very homogeneous manner. For this purpose, the reactor system is advantageously in a design in which each reaction channel of a channel structure element (9) has at least two inlets (10, 10′), and each reaction channel of a channel structure element preferably has three inlets (10, 10′, 10″).

The studies conducted by means of the reactor system are characterized by a high data quality since the process parameters can be controlled very accurately. The process parameters include the dwell time, the mixing of the fluids and the provision of defined contact surfaces.

In a further embodiment, the reactor system of the invention is equipped with sensor elements by means of which the process parameters can be registered during the performance of the catalytic studies.

The reactor system of the invention also offers the advantage that it can be used in a modified form in a high-throughput apparatus. It is a characteristic feature of a high-throughput apparatus that it is equipped with a plurality or multitude of reaction channels. There are conceivable embodiments in which the channel structure elements are in a modified form, wherein a single channel structure element (9) may have two or more reaction channels. The corresponding reaction system in that case has a greater number of feed channels and outlet channels by which reactant fluid is supplied to the individual reaction channels of the channel structure element (9). Another conceivable embodiment is one in which a reaction system has been provided with a multitude of channel structure elements. For example, it is also possible for four channel structure elements (9) in a circular configuration to be positioned in the contact surface of a block. The multitude of channel structure elements (9) may then in turn be sealed by a common sealing element, or each channel structure element (9) by a dedicated sealing element. The reaction system in that case has a corresponding number of inlets and outlets that serve to supply the reaction channels with the corresponding fluids (i.e. reactant fluid or product fluid) or to remove these from the reaction channels. In the case of a correspondingly small design of the reaction systems, it is of course possible on to operate two or more of these reaction systems as independent elements in the same apparatus in a parallel arrangement.

Table A.1 shows an overview of the dimensioning of the reaction spaces for different channel structure elements that are determined by the diameter of the channel structure element and the channel structure configuration—in an embodiment as reactor system for research purposes. In the present case, the dimensioning is shown for channels having a diameter of 1 mm and a depth of 0.5 mm, with the channels having a meandering structure incorporated into the surface of the channel structure element.

| Length of a | | Channel | | |
|---|---|---|---|---|
| channel | Number of | length within | Channel | Channel |
| within the | channels in | the element | volume | volume |
| surface [mm] | element | [mm] | [mm³] | [cm³] |
| 20 | 9 | 113 | 90 | 0.09 |
| 30 | 14 | 270 | 210 | 0.21 |
| 40 | 19 | 493 | 380 | 0.38 |
| 50 | 24 | 783 | 600 | 0.60 |
| 100 | 49 | 3233 | 2450 | 2.45 |
| 150 | 74 | 7350 | 5556 | 5.55 |
| 200 | 99 | 13133 | 9900 | 9.90 |

The reactor system of the invention is elucidated with reference to the details that are shown in the figures, but should not be regarded in any way as limiting in respect of the invention. FIG. 2.a shows that the channel structure element (9) may be positioned on the surface of the depression of the block (2) or may be integrated into the surface of this block. The block (1) is disposed above the block (2), with the sealing element (8) and the channel structure element (9) disposed between the contact surfaces of the blocks (1, 2). In the embodiment shown in FIG. 2.a, the connection of the inlet and the outlet runs through the sealing element (8). FIG. 2.b shows a modified embodiment in which the reactor system has been provided with two channel structure elements (9) and (9′). In this embodiment, it should be noted that the sealing element must have two passages that assure the connection of the upper channel structure element (9) and lower channel structure element (9′). By virtue of the arrangement of multiple channel structure elements, it is possible to extend the length of a reaction channel without simultaneously having to increase the diameter of the reactor system. A further embodiment of the reactor system of the invention with a stacked arrangement of two channel structure elements (9) or one channel structure element (9) that exhibits a double element is given in FIG. 2.c. The arrangement has the characteristic feature that the channels of the superposed channel structure elements (9) are offset. In addition, each of the two channel structure elements (9) is sealed by a sealing element (8) and a sealing element (8′). The upper sealing element (8) has passages that connect the inlet (10) and outlet (11) to the reaction channel of the upper channel structure element (9). In this embodiment with two channel structure elements (9), there must also be a connection between the reaction channel of the upper channel structure element (9) with the reaction channel of the lower channel structure element (9). FIG. 3 shows an embodiment of the reactor system which is equipped with a catalyst film (15) and which is particularly preferred. The catalyst film (15) is disposed between the sealing element (8) and the channel structure element. The feed conduit (10) and the outlet (11) lead through the channel structure element (9), with the passage in FIG. 3 identified by the reference numeral (14) on the left-hand side of the channel structure element (9). The catalyst film (15) may be provided with sealing means (16) in the edge region. This edge region is the edge region in the immediate proximity of the reaction channel, which should be distinguished from the outer edge region (6). The outer edge region (6) serves for the contact pressure device, for example for the passage of securing elements, in the form of screws (as shown in FIG. 5 by passages (17)). FIG. 4.a and FIG. 4.b show the reactor system of the invention without the elevation in the form of a die and the recess in the form of a die plate, which is apparent in FIG. 1, 2.a, 2.b, 2.c or else FIG. 3. FIG. 4.b shows a contact pressure device (3) in the form of clamps. In FIG. 4.a and in FIG. 4.b, the channel structure element is integrated into the block (1) in each case.

Another advantageous aspect of the modular arrangement is that the elements of the reactor system can be combined in a flexible manner. In a further embodiment, the reactor system for continuous flow reactions comprises a channel structure element (9) which is disposed between an upper and a lower sealing layer (8) and which has a catalyst film (15) in each case both between the upper and the lower sealing layer.

FIG. 5 shows a schematic top view of the surface of a block of the reactor system of the invention in a preferred embodiment. It is not apparent here whether the circular region in the center is elevated or depressed. The region in the inner region of the contact surface is identified by reference numerals (4) and (5). This is the central region in which the channel structure element (9) is disposed. The reference numerals (4) and (5) have been chosen since the contact surface can be that within the depression or the contact surface within the elevation. FIG. 5 also shows the meandering course of the reaction channel with the land (19) between adjacent channel sections. A certain land width is important since the sealing element or the catalyst film forms a sealing connection to the land. Preferably, the land width is in the region of ≥0.1 cm. Further preferably, the land width is ≥0.2 cm. Two configurations of the meandering reaction channel are shown in FIGS. 6.a and 6.b, with FIG. 6.a showing a reaction channel with circular curves and FIG. 6.b a reaction channel with angular curves. FIG. 7.a shows an embodiment of a reaction channel that has a mixing element (21) at the start of the reaction channel. The mixing element (21) has been provided with baffle elements (22) that enable mixing of the reactant fluid supplied. In FIG. 7.a, the contact point of the feed to the mixing element (21) is identified by reference numeral (23). FIG. 7.b shows an embodiment in which the mixing element (21) is equipped with two feed conduits—specifically with the feed conduits having connection points (23) and (24). FIG. 8.a shows a schematic diagram of a detail of the reactor system in the open state, with a catalyst film (15) disposed between the channel structure element (9) and the sealing element (8). FIG. 8.b shows a detail from the reactor system corresponding to the detail in FIG. 8.a, except that the reactor system is shown in the closed state. FIG. 8.b shows the principle of function by which the catalyst film (15) in conjunction with the sealing element (8) leads to a form-fitting seal of the land surfaces of the channel structure element (9).

In a further embodiment, the reactor system is used to conduct studies in methods that are performed in the presence of multiphase reactant fluids having zero or only limited miscibility. A hallmark of the performance of studies in the presence of those reactant fluids that are poly-phasic and have only low miscibility is that the method is preferably conducted in operation with Taylor flow. The conditions of Taylor flow can be controlled in a very accurate manner by means of the reactor system of the invention. Different Taylor flow conditions are illustrated by the diagram in FIG. 9.a. The upper part and the middle part show sections of a reaction channel through which a Taylor flow with a biphasic system composed of gas and liquid is guided. In the channel section (25), the air bubbles are more significantly compressed than in the channel section (25′). The lower part shows a section of a reaction channel (25″) through which two liquids flow in Taylor flow. The two liquids show a plug flow profile of individual flow plugs that alternate with one another.

### EXAMPLES

For illustration of the invention, using the reactor system of the invention, the catalytic oxidation of glucose was examined, which is elucidated hereinafter. A reactor system having blocks manufactured from stainless steel was, the construction of which in the embodiment was like the reactor system shown in FIG. 2. One block of the reactor system was provided with a die that had a die diameter of 2 cm; the second block was equipped with an opening in the form of a hole for introduction of the die. In the experiments, different interlayers were used in the cavity space between the two blocks. For closure of the reactor system, the blocks were pressed against one another with screws in order thus: a) to press the structure element against the sealing plate or b) to press the structure element against the catalyst foil and the sealing plate.

In the studies, the reactor system of the invention was used in an air circulation oven by means of which temperature control of the reactor system was assured. The feed conduit of the reactor system was connected to a mixing element that equips both with a feed for liquids and with a feed for gases. The liquid feed was connected by a conduit to a high-pressure pump and a reser-voir vessel that had been filled with an aqueous glucose solution (90 mg/L). The gas feed was connected to regulators and the gas supply conduit, and it was possible by means of the gas supply to feed in different gases at the desired flow rate. The outlet of the reactor system was connected to a removal vessel for the removal of gases and waste air conduits. The product fluid led off from the reactor system was characterized by means of gas chromatography, using an Agilent GC with a 10 meter column.

For the characterization of the blank activity of the reactor system, a series of test studies for oxidation of glucose solution was conducted, in which the dwell time and temperature were changed. The results of these tests studies are shown in table 1. The glucose solution that had a glucose content of 90 mg of glucose per liter of water was used. The solution having the same glucose content was also used in the other test studies that are detailed in the present examples. The oxidation reactions were conducted at 50 bar, and the temperature levels chosen in the studies here were 130° C., 150° C. and 170° C. The flow rates of the glucose solution and of the oxygen were each 0.1 mL/min. The dwell times that characterize the time spent by the reaction solution in the reaction space of the reactor system were 7.5 seconds, 15 seconds, 30 seconds and 60 seconds.

In order to give a more detailed illustration of the range of use of the reactor system at different operating points, a series of test studies for oxidation of glucose solutions was conducted, which were performed in the presence or in the absence of a catalyst foil. The results of this study are shown in table 2. The catalyst foil used was a platinized platinum foil, and the studies were conducted at a reactor temperature of 130° C. and a pressure of 50 bar.

Table 1 shows a series of blank measurements in which the glucose solution and oxygen were each conveyed through the reactor system at different flow rates.

| | | Conversion | Conversion | Conversion |
|---|---|---|---|---|
| | Dwell | [%] at | [%] at | [%] at |
| | time [s] | T = 130° C. | T = 150° C. | T = 170° C. |
| | 3.25 | <1 | <1 | 4.0 |
| B2 | 7.5 | 2.2 | 4.0 | 5.0 |
| B3 | 15 | 4.9 | 5.1 | 5.1 |
| B4 | 30 | 6.4 | 9 | 15 |
| B5 | 60 | 6.5 | 12 | 28 |

Table 2 shows a series of experiments that were conducted at a reactor temperature of 130° C. and different flow rates in the presence and absence of a catalyst foil, by determining the conver-sion as a function of the time on stream (also called TOS hereinafter) or the experiment duration.

| | Flow rate of gl. | Conversion | Conversion | Conversion |
|---|---|---|---|---|
| | soln. | [%] at | [%] at | [%] at |
| | [mL/min] | TOS = 1 h | TOS = 2 h | TOS = 3 h |
| | 0.05 | 5 | 9 | 5 |
| B7 | 0.1 | 14 | 5 | 3 |
| B8 (Cat) | 0.05 | 70 | 64 | 63 |
| B9 (Cat) | 0.1 | 43 | 48 | 50 |

Table 3 shows a series of experiments B10-B12 that were conducted at a reactor temperature of 150° C., a pressure of 9 bar and flow rates of glucose solution and air each of 0.05 mL/min. The structure element used in the reactor system was manufactured from Teflon.

| | Conver- | Conver- | Conver- | Conver- | Conver- |
|---|---|---|---|---|---|
| | sion | sion | sion | sion | sion |
| | [%] at | [%] at | [%] at | [%] at | [%] at |
| | TOS = 1 h | TOS = 2 h | TOS = 3 h | TOS = 4 h | TOS = 5 h |
| B10 (blank) | 16 | 12 | 14 | 8 | |
| B11 (cat) | 65 | 66 | 56 | 68 | 82 |
| B12 (cat) | 73 | 74 | 68 | 60 | 76 |

Table 4 shows a series of experiments B13-B16 that were conducted at a reactor temperature of 150° C., a pressure of 9 bar and flow rates of glucose solution and air each of 0.05 mL/min or of 0.1 mL/min. The structure element used in the reactor system was manufactured from Teflon.

| | Conver- | Conver- | Conver- | Conver- | Conver- |
|---|---|---|---|---|---|
| | sion | sion | sion | sion | sion |
| | [%] at | [%] at | [%] at | [%] at | [%] at |
| | TOS = 1 h | TOS = 2 h | TOS = 3 h | TOS = 4 h | TOS = 5 h |
| B13 - 0.05 | 16 | 11 | 12 | 8 | / |
| B14 - 0.1 | 9 | 11 | 8 | 10 | / |
| B15 (cat) - | 66 | 68 | 64 | 63 | 56 |
| 0.05 | | | | | |
| B16 (cat) - | 55 | 58 | 54 | 54 | 55 |
| 0.1 | | | | | |

Table 5 shows a series of experiments B17-B21 that were each conducted at a pressure of 50 bar. All experiments B17-B21 were conducted with the same catalyst sample.

| | | Temperature | Dwell time | | Conversion |
|---|---|---|---|---|---|
| | Reactant | [° C.] | [h] | Catalyst | [%] |
| | Glucose | 120 | 1 | Pt on ex- | 100 |
| | | | | panded | |
| | | | | graphite | |
| | Glucose | 120 | 1 | Pt on ex- | 72 |
| | | | | panded | |
| | | | | graphite | |
| B19 | Glucose | 80 | 6 | Pt on ex- | 83 |
| | | | | panded | |
| | | | | graphite | |
| B20 | HMF | 50 | 4 | Pt on ex- | 52 |
| | | | | panded | |
| | | | | graphite | |
| B21 | HMF | 50 | 6 | Pt on ex- | 100 |
| | | | | panded | |
| | | | | graphite | |

In the experiments, sealing elements made of graphite film or of Teflon film were used. In addition, channel structure elements manufactured from Teflon or from stainless steel were used.

### BRIEF DESCRIPTION OF THE FIGURES

FIG. 1 shows the schematic diagram of a reaction system in cross section. The two blocks (1, 2) are not connected and the reaction system is in the open state, with the channel structure element (9) integrated into the connecting surface (5) of the first block (1).

FIG. 2.a shows the schematic diagram of the reaction system shown in FIG. 1, with the channel structure element (9) integrated into the connecting surface (4) of the second block (2).

FIG. 2.b shows a schematic diagram of a reaction system in which both the connecting surface (5) of the first block is equipped with a channel structure element (9) and the connecting surface (4) of the second block (2) is equipped with a channel structure element (9′). The figure does not show the passages in the sealing element (8).

FIG. 2.c shows a schematic diagram of a reaction system in which the channel structure element (9) is in separate form and hence is not integrated into the connecting surfaces of the blocks (1, 2). The channel structure element (9) is surrounded by the sealing elements (8) and (8′). The channel structure element (9) is in the form of a stacked element which is formed from two different channel structure elements (9), with the superposed elements having offset channels.

FIG. 3 shows a schematic diagram of a reaction system in which, in the stacked arrangement, a catalyst film (15) is disposed between the channel structure element (9) and the sealing element (8). The catalyst film (15) is sealed by the lateral seal (16). In the channel structure element (9), there is a conduit passage that enables the supply of fluid through the conduit (10) into the channel.

FIG. 4.a shows a schematic diagram of a reaction system in the open state in which the channel structure element (9) is integrated into the connecting surface (5) of the first block. In this case, block (1) is equipped without a flat die tip and block (2) without a depression.

FIG. 4.b shows a schematic diagram of a reaction system in the closed state, with the two blocks (1, 2) connected by means of the securing elements (3), with the sealing element (8) pressed against the channel structure element (9).

FIG. 5 shows a schematic diagram of a block (i.e. block (1) or block (2) in top view, showing a circular connection surface). This may be a connection surface (4) or a connection surface (5) into which a channel structure element (9) is integrated, characterized by channels in the form of loops. A land (19) is apparent between the adjacent channels. Passages (17) are shown in the edge region (6) of the block, through which the securing elements (3) are conducted.

FIG. 6.a shows a schematic diagram of a channel section with six circular curves comprising three channel segments.

FIG. 6.b shows a schematic diagram of a channel section with right-angled curves. The six right-angled curves comprise three channel segments.

FIG. 7.a shows a schematic diagram of a channel section with its entry region connected to the mixing element (21), where the element (23) represents the connection of the inlet (10) to the mixing element (21). Baffles (22) are disposed within the mixing element.

FIG. 7.b shows a schematic diagram of a channel section with its entry region attached to the mixing element (21), with the mixing element having two connecting elements (23, 24) to the inlets (10, 10′).

FIG. 8.a shows a schematic diagram of a cross section through the middle region of a reaction system with the elements in a stacked arrangement in the open state, with a catalyst foil (15) coated with catalyst particles on its surface disposed in the region between the channel structure element (9) and the sealing element (8).

FIG. 8.b shows a schematic diagram of a cross section through the middle region of a reaction system with the elements in a stacked arrangement, corresponding to the diagram in FIG. 8.a, except that the reaction system is closed. The catalyst film is pressed against the lands of the channel structure elements.

FIG. 9 shows a schematic diagram of details from reaction channels through which biphasic fluid streams flow in Taylor flow, showing a gaseous fluid and a liquid fluid in the case of channel section (25) and channel section (25′). Channel section (25″) shows a flow of two liquid, immiscible fluids.

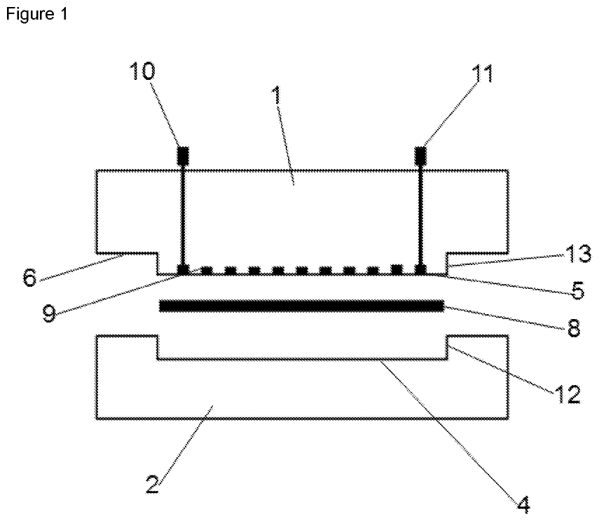

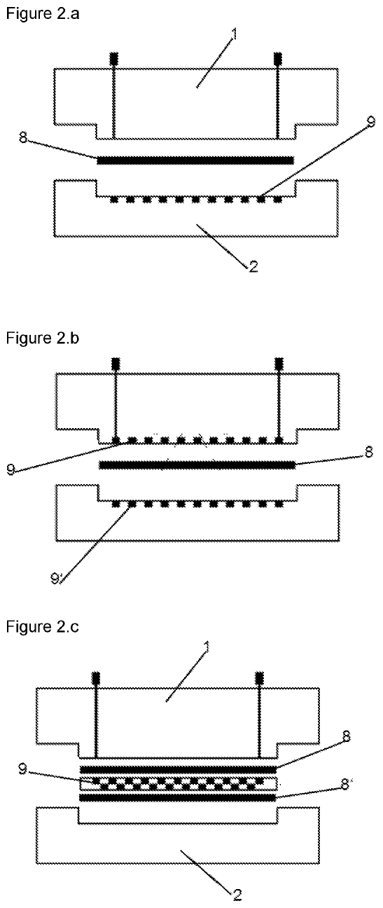

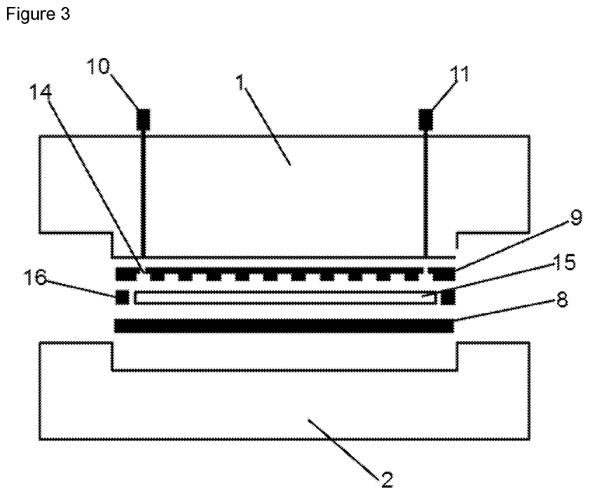

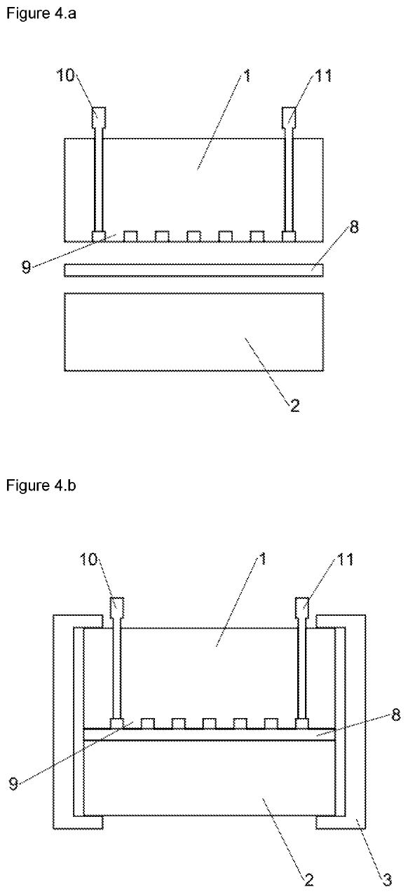

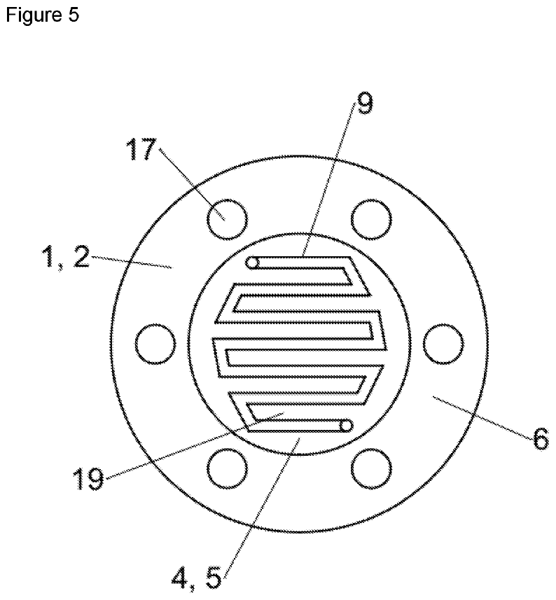

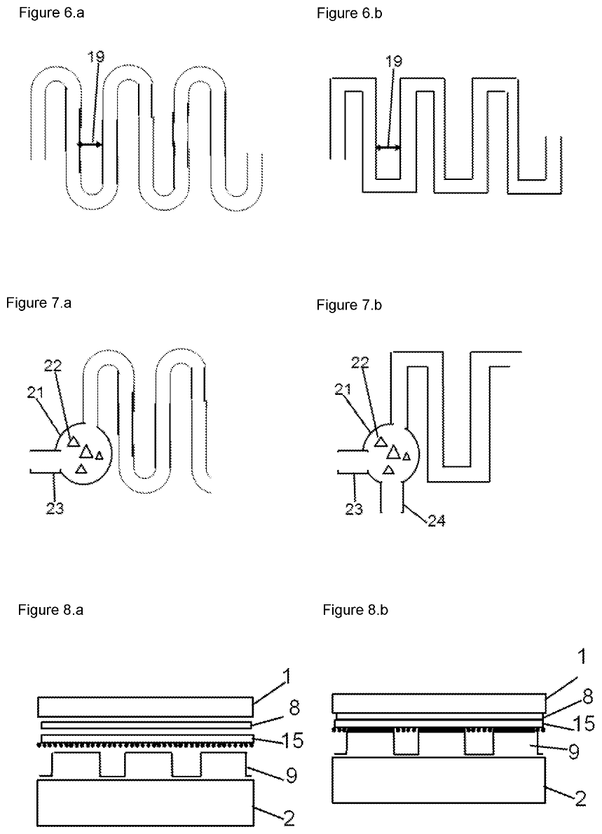

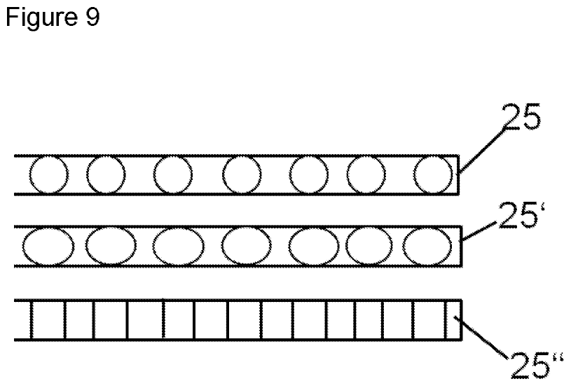

### LIST OF REFERENCE NUMERALS

| | | |
|---|---|---|
| 1 | — | first block or first plate |
| 2 | — | second block or second plate |
| 3 | — | securing elements |
| 4 | — | connecting surface |
| 5 | — | connecting surface |
| 6 | — | edge region |
| 8 | — | sealing element |
| 9, 9′ | — | channel structure element, microchannel structure |
| | | element |
| 10, 10′, 10″′ | — | inlets |
| 11 | — | outlet |
| 14 | — | conduit passage within the channel structure |
| | | element, or the micro-channel structure element |
| 15 | — | catalyst film |
| 16 | — | lateral seal (seal of the catalyst film) |
| 17 | — | passage for securing element |
| 19 | — | land between adjacent channels |
| 21 | — | mixing element within the channel structure element |
| 22 | — | baffle within the mixing element |
| 23 | — | end piece of the inlet (10) |
| 24 | — | end piece of the inlet (10′) |
| 25, 25′, 25″ | — | details from a channel section with different |
| | | Taylor flow packages |

1.-15. (canceled)

16. A reactor system for continuous flow reactions that comprises at least two blocks, two interlayers and a contact pressure device, and at least one inlet and one outlet, wherein the first block, the interlayers and the second block form a stacked arrangement fixed by the contact pressure device and, in the reactor system, at least one interlayer comprises a sealing layer and one interlayer comprises channel structure element comprising a reaction channel, wherein the reaction channel of the channel structure element takes a meandering course and the diameter of the reaction channel is in the range of 50-2500 μm and the depth of the reaction channel in the range of 10-1500 μm, and wherein the inlet is functionally connected to the inlet side of the reaction channel and the outlet to the outlet side of the reaction channel, and the stacked arrangement is detachable.

17. The reactor system for continuous flow reactions according to claim 16, wherein a catalyst foil is disposed between the sealing layer and the channel structure element.

18. The reactor system for continuous flow reactions according to claim 16, wherein one of the blocks, on the contact side with the opposing block, has an elevation or the shape of a die with a flat end face and one of the blocks, on the contact side with the opposing block, has a depression with a flat base and, in the presence of the stacked arrangement, the elevation or die is positioned in the depression and the interlayers are disposed in the region between the end face of the die and the base of the depression.

19. The reactor system for continuous flow reactions according to claim 16, wherein the interlayers have a diameter in the range of 0.5-200 cm.

20. The reactor system for continuous flow reactions according to claim 16, wherein at least one interlayer that comprises a channel structure element forms an integral constituent of the contact surface of one of the blocks, or the respective interlayer that takes the form of a channel structure element form integral constituents of the contact sides of the respective blocks.

21. The reactor system for continuous flow reactions according to claim 16, wherein each reaction channel of a channel structure element has at least two inlets.

22. The reactor system for continuous flow reactions according to claim 16, wherein each reaction channel of a channel structure element has at least three inlets.

23. The reactor system for continuous flow reactions according to claim 16, wherein at least one sealing layer has a thickness in the range of 0.1-10 mm.

24. The reactor system for continuous flow reactions according to claim 16, wherein at least one of the interlayers comprises a compressible, viscoelastic or plastic material, the compressible, viscoelastic or plastic material.

25. The reactor system for continuous flow reactions according to claim 16, wherein at least one of the interlayers comprises a compressible, viscoelastic or plastic material, the compressible, viscoelastic or plastic material selected from the group consisting of Teflon, Polyoxymethylene (POM), and inorganic materials.

26. The reactor system for continuous flow reactions according to claim 16, wherein at least one of the interlayers comprises a compressible, viscoelastic or plastic material, the compressible, viscoelastic or plastic material selected from the group consisting of Teflon, polyoxymethylene (POM), and inorganic materials selected from the group consisting of a carbonaceous material and a metal-containing material.

27. The reactor system for continuous flow reactions according to claim 16, wherein the blocks comprise a metallic material selected from the group of copper, brass, aluminum, iron, iron-containing steel, stainless steel, nickel-chromium stainless steel, high-alloy corrosion-resistant stainless steels.

28. The reactor system for continuous flow reactions according to claim 16, wherein the reaction channel of the channel structure element has been filled with catalyst or is in coated form.

29. The reactor system for continuous flow reactions according to claim 16, integrated into an apparatus for performance of catalytic test reactions, wherein the apparatus comprises a reactant feed for supply of liquids and/or gases, including carrier fluid in the form of liquids and gases, the reactant feed comprises elements from the group of mass flow controller, high-pressure pump, gas saturator, the apparatus further comprising means of analysis of the product streams, and the apparatus further having been equipped with a control and/or monitoring device.

30. A method of performing catalytic reactions by means of a reactor system according to claim 16, wherein the method is performed with supply of liquid and/or gaseous reactants in the presence of a solid-state catalyst disposed in channel structure element or the microscale channel structure element; in an alternative execution of the method, the method is performed with supply of liquid reactants and/or carrier fluid comprising a homogeneous catalyst in dissolved form.

31. A method of performing catalytic reactions by means of a reactor system according to claim 16, wherein the method is performed with supply of liquid and/or gaseous reactants in the presence of a solid-state catalyst disposed in channel structure element or the microscale channel structure element, the solid-state catalyst further being disposed in the form of a film between the sealing element and the channel structure element or the microscale channel structure elements; in an alternative execution of the method, the method is performed with supply of liquid reactants and/or carrier fluid comprising a homogeneous catalyst in dissolved form.

32. The method of performing catalytic reactions by means of a reactor system according to claim 30, wherein the reactor system is stored at a temperature in the range of 20-200° C.

33. The method of analyzing catalysts according to claim 30, wherein the method is performed at a pressure in the range of 0.05-300 barg.

34. The method of analyzing catalysts according to claim 30, wherein the method is performed at a pressure in the form of a high-pressure method at a pressure in the range of 10-300 bar.

35. The method of analyzing catalysts according to claim 30, wherein the method is performed at a flow rate in the range of 0.05-100 mL/min.
